(19) United States
(12) Patent Application Publication
(10) Pub. No.: US 2009/0115747 A1
(43) Pub. Date: May 7, 2009

(54) Digital notebook

(76) Inventor: Chi-Cheng Gung, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,387

(22) Filed: Nov. 2, 2007

(51) Int. Cl. G06F 3/037

(52) U.S. Cl. 345/180

(57) ABSTRACT

This invention relates to a digital notebook which comprises a pen, a USB storage unit and paper. The pen is provided with a wireless transmission module. The USB storage unit is provided with a wireless reception module, a processing module and a data storage module, and the USB storage unit is fixed on the paper. When a writing action is conducted by the pen on the paper, the wireless transmission module of the pen continuously transmits signals which are then received by the wireless reception module of the USB storage unit. The signals are stored in the data storage module after they are operationally processed by the processing module. After the digital notebook is connected to a personal computer through the USB port on the USB storage unit, the data written on the paper can be displayed on the personal computer.

### BACKGROUND OF THE INVENTION

1. Field of the Invention

The present invention relates to a digital notebook, particularly to a digital notebook in which the data written by the pen on the paper is transmitted by the wireless transmission module provided in the pen and the wireless reception module provided in the USB storage unit, and is operationally processed by the processing module, and then the data written by the pen on the paper is converted into digital data and is stored in the data storage module of the USB storage unit.

2. Brief Description of the Prior Art

Generally, the characters or the pictures written by an ordinary pen (such as a pencil, a ball pen, a fountain pen and etc.) are unable to be converted into digital data required for conducting electronic transmission. Therefore, the characters or the pictures can only be inconveniently carried out by written on a paper note. Besides, the characters or the pictures written on the paper can be scanned by a scanner to form a digital image file to be stored for conducting digital transmission. However, because the characters or the pictures written on the paper are directly scanned by a scanner to form a digital image file, further editing on the characters or the pictures can not be done.

### SUMMARY OF THE INVENTION

In view of the above fact, the inventor of the present invention provides the present invention based on his endless effort according to the abundant professional knowledge accumulated and the practical experience in the relevant field.

The main object of the present invention is to provide a digital notebook in which the data written by a pen on paper can be converted into digital data and stored in the USB storage unit.

The object and effectiveness of the digital notebook of the present invention can be realized by the following technology.

The digital notebook of the present invention comprises a pen, a USB storage unit and paper, said pen being provided with a wireless transmission module, said USB storage unit being provided with a wireless reception module, a processing module and a data storage module; when a writing action is conducted by the pen on the paper, the wireless transmission module of the pen continuously transmits signals which are then received by the wireless reception module of the USB storage unit, the signals being stored in the data storage module after they are operationally processed by the processing module.

The digital notebook is further connected to a personal computer through the USB port on the USB storage unit so that the digital data stored in the data storage module of the USB storage unit can be downloaded to the personal computer by interlinking. Therefore, the data written on the paper can be displayed on the personal computer.

The digital notebook of the present invention further allows the USB storage unit to be fixed on the paper. The fixing method is to use a clip element for the clipping action.

### BRIEF DESCRIPTION OF THE DRAWINGS

The present invention will be better understood by the detailed description of the following preferred embodiment with reference to the accompanying drawings, in which:

FIG. 1 is a structural schematic view showing the digital notebook of the present invention.

FIG. 2 is a block schematic view showing the digital notebook of the present invention.

FIG. 3 is a schematic view showing the USB storage unit of the digital notebook of the present invention fixed on the paper of the present invention.

FIG. 4 is a schematic view showing one example of the paper of the digital notebook of the present invention.

FIG. 5 is a schematic view showing another example of the paper of the digital notebook of the present invention.

### DETAILED DESCRIPTION OF THE PREFERRED EMBODIMENTS

The technical contents of the present invention will become more apparent from the detailed description of the preferred embodiment in conjunction with the accompanying drawings.

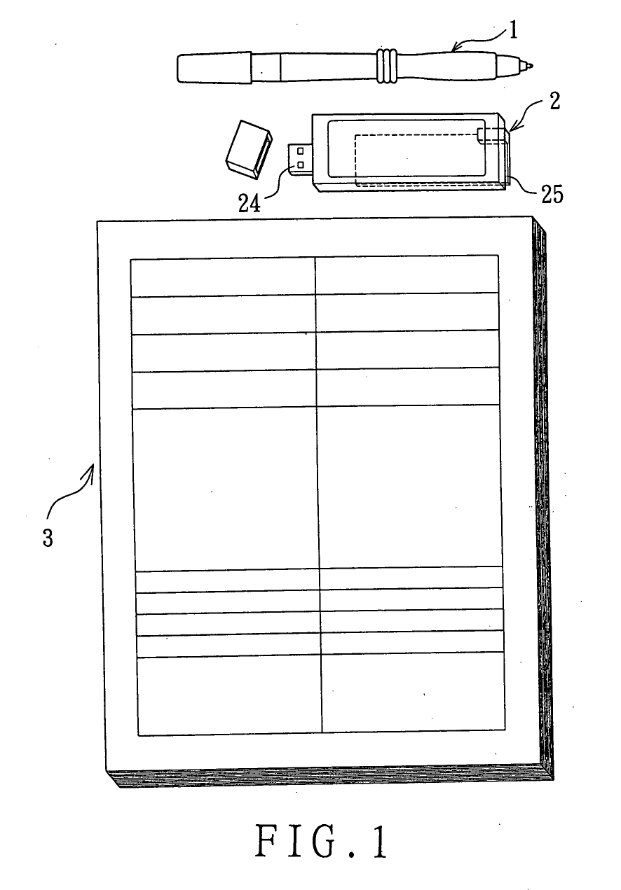

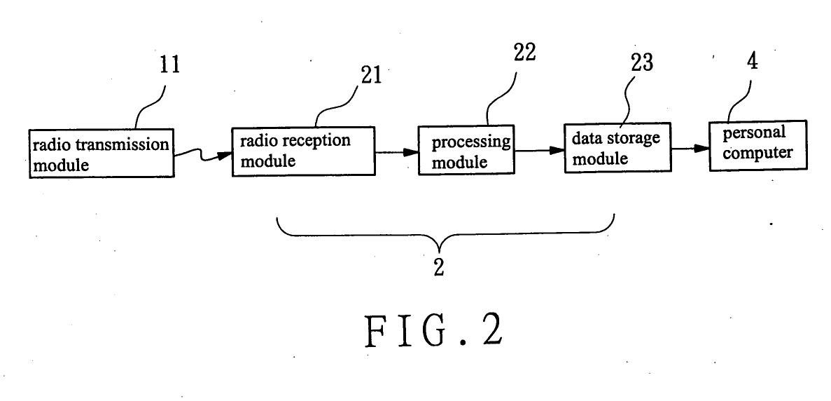

Firstly referring to FIGS. 1 and 2, the digital notebook of the present invention comprises a pen (1), a USB storage unit (2) and paper (3), wherein:

the pen (1) is an ordinary pen (such as a pencil, a ball pen or a fountain pen) which is provided with a wireless transmission module (11) capable of transmitting signals;

the USB storage unit (2) is provided with a wireless reception module (21), a processing module (22) and a data storage module (23). The wireless reception module (21) can receive the signal transmitted from the wireless transmission module (11) of the pen (1). The signal thus received by the wireless reception module (21) is transmitted to the processing module (22) where the signal is operationally processed to become digital data. Then, the digital data is transmitted to the data storage module (23) and is stored therein. After the digital notebook is connected to a personal computer (4) through the USB port (24) on the USB storage unit (2), the digital data can be transferred to the personal computer (4) for further editing operation. The data storage module (23) can be a flash memory.

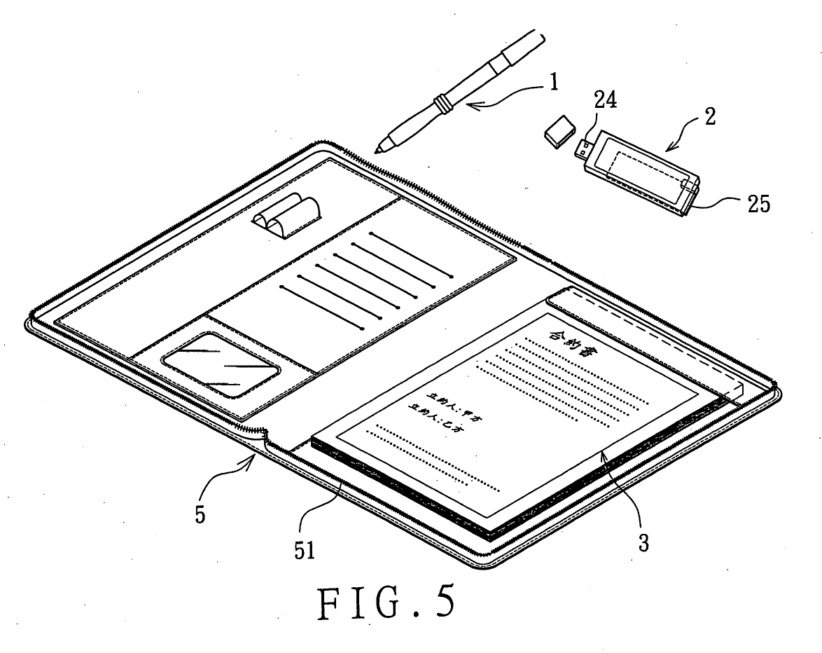

The paper (3) can be an ordinary paper product, which is combined by a number of sheets to form a booklet. The paper (3) can also be clipped in a document file (5) (as shown in FIG. 5). The peripheries of the two sides of the document file (5) can be provided with zippers (51) so as to enclose the paper (3) within the document file (5).

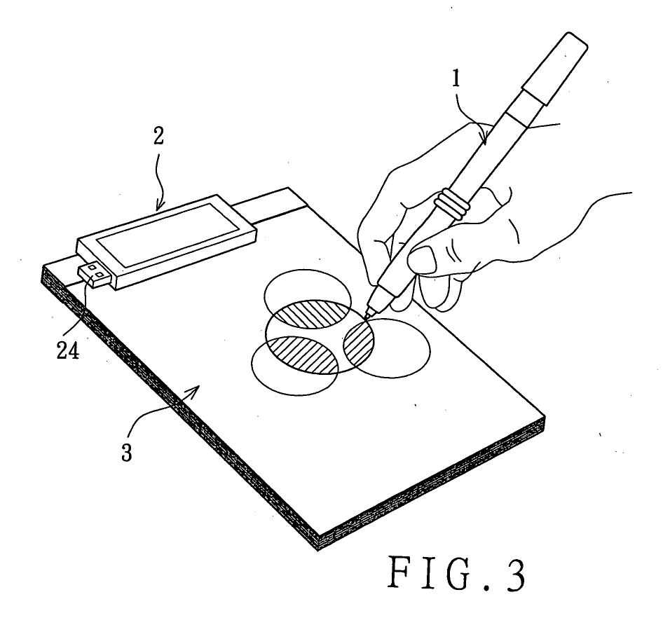

When a writing action is conducted by the pen (1) on the paper (3)(as shown in FIG. 3), the wireless transmission module (11) of the pen (1) continuously transmits signals which are then received by the wireless reception module (21) of the USB storage unit (2). The signals received by the wireless reception module (21) are further transmitted to the processing module (22) and are conducted with operational processing therein to convert the characters or pictures written by the pen (1) on the paper (3) into digital data. Then, the digital data is transmitted to and is stored in the data storage module (23).

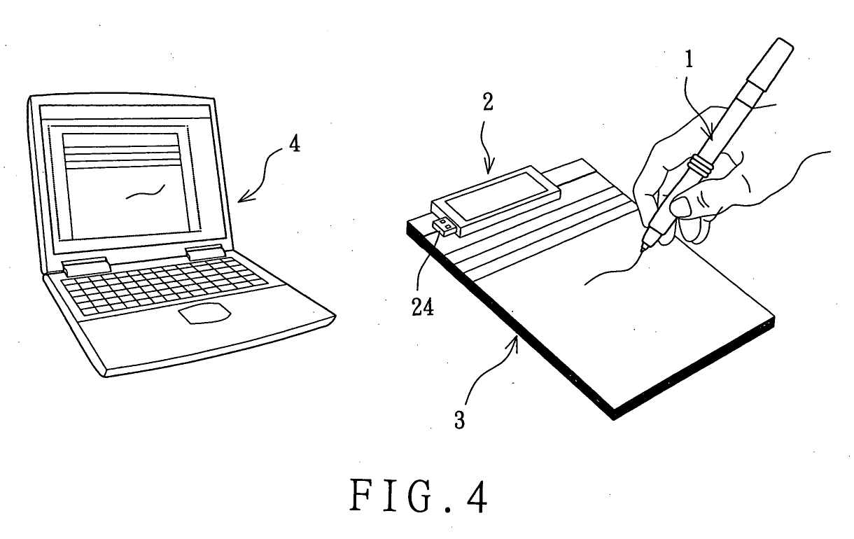

If the USB storage unit (2) is linked with the personal computer (4)(as shown in FIG. 4), the characters or the pictures written by the pen (1) on the paper (3) and converted into digital data and stored in the data storage module (23) of the USB storage unit (2) can be downloaded to the personal computer (4). Therefore, the characters or the pictures written on the paper (3) can be displayed on the personal computer (4).

The digital notebook of the present invention further has a clip element (25) provided on the USB storage unit (2). Thus, the USB storage unit (2) is clipped on the paper (3) by the clip element (25). The clip element (25) is a back clip.

Furthermore, the sheets of the paper (3) of the digital notebook of the present invention is printed with various data field. On the other hand, an application software is installed within the personal computer (4). The application software has template files corresponding to the printed data field on the sheets of the paper (3) such that the same data as the characters or pictures written on the paper (3) is presented on the template file displayed on the personal computer (4) after a user downloads the data stored in the USB storage unit (2) to the personal computer (4). Furthermore, the application software of the personal computer (4) can be installed with various template files having different field formats so as to cope with the paper (3) having various different fields.

In the digital notebook of the present invention, the pen (1) is further furnished with a number of leads with different colors. Each lead is set to issue a different signal such that the color of the characters or the pictures displayed on the personal computer (4) can match to the lead color used on the pen (1) by the distinction of different signal values.

Based on the foregoing, this invention surely has the following advantages when comparing with prior art.
1. In the present invention, when a writing action is conducted by the pen on the paper, the wireless transmission module of the pen continuously transmits signals which are then received by the wireless reception module of the USB storage unit. The signals are stored in the data storage module after they are conducted with operational processing by the processing module. After the digital data thus stored is downloaded to a personal computer through the linking at the USB port on the USB storage unit, the data written on the paper can be displayed on the personal computer.
2. In this invention, the data written by the pen on the paper is received through the USB storage unit, and is stored again after conducting with operational processing. Therefore, the portability of the data with the USB storage unit is relatively good for users.
3. In this invention, the data written on the paper can be converted into digital data and can be downloaded to the personal computer such that further word processing in the personal computer is possible.

Summing up above, the embodiment of this invention can reach expected effectiveness, and the specific configurations disclosed herein have yet not seen in the prior art of the same category of product, even has not been opened to the public before application.

While the present invention has been described with preferred embodiment in conjunction with the accompanying drawings, it is noted that the preferred embodiment and the drawings are purely for the convenience of description only, not intended to be restrictive on the scope of the present invention. Modifications and variations or equivalents of the present invention without departing from the spirit of the present invention are considered to be still within the scope of the present invention.

What is claimed is:

1. A digital notebook, comprising:
a pen provided with a wireless transmission module;
a USB storage unit provided with a wireless reception module, a processing module and a data storage module, said wireless reception module receiving a signal transmitted from said wireless transmission module and transferring the signal to said processing module, the signal being stored in said data storage module after it is operationally processed by said processing module; and
paper on which said pen can write.

2. A digital notebook as claimed in claim 1, wherein said pen is a pencil.

3. A digital notebook as claimed in claim 1, wherein said pen is a ball pen.

4. A digital notebook as claimed in claim 1, wherein said data storage module is a flash memory.

5. A digital notebook as claimed in claim 1, wherein said paper is assembled within a document file.

6. A digital notebook as claimed in claim 5, wherein the peripheries of the two face of said document file is provided with zippers.

7. A digital notebook as claimed in claim 5, wherein said paper is combined by a number of sheets to form a booklet.

8. A digital notebook as claimed in claim 1, wherein the digital data stored within said data storage module can be downloaded to the personal computer after said USB storage unit is linked with said personal computer through the USB port provided on said USB storage unit.

9. A digital notebook as claimed in claim 8, wherein said paper is printed with various data fields, and on the other hand, template files corresponding to the printed data fields on said paper are installed within the personal computer such that the same data as the characters or pictures written on the paper is presented on the template file displayed on the personal computer after a user downloads the data stored in the USB storage unit to the personal computer.

10. A digital notebook as claimed in claim 9, wherein various template files having different field formats are installed within the personal computer so as to cope with the paper having various different fields.

11. A digital notebook as claimed in claim 1, wherein said USB storage unit is provided with a clip element by which said USB storage unit is clipped on said paper.

12. A digital notebook as claimed in claim 11, wherein said clip element is a back clip.

13. A digital notebook as claimed in claim 1, wherein said pen is provided with a number of leads with different colors, each lead being set to issue a different signal such that the color of the characters or the pictures displayed on the personal computer can match to the lead color used on said pen by the distinction of different signal values.

14. A digital notebook as claimed in claim 1, wherein said paper is combined by a number of sheets to form a booklet.

15. A digital notebook as claimed in claim 1, wherein said paper is printed with various data fields, and on the other hand, template files corresponding to the printed data fields on said paper are installed within the personal computer such that the same data as the characters or pictures written on said paper is presented on the template file displayed on the personal computer after user downloads the data stored in said USB storage unit to the personal computer.

16. A digital notebook as claimed in claim 15, wherein various template files having different field formats are installed within the personal computer so as to cope with the paper having various different fields.
